(19) United States
(12) Patent Application Publication
(10) Pub. No.: US 2024/0239145 A1
(43) Pub. Date: Jul. 18, 2024

(54) DEVICE FOR HOLDING A HOOK TO A VEHICLE, AND RELATED METHODS AND COMPONENTS

(71) Applicant: Zacklift International, Cle Elum, WA (US)

(72) Inventor: Matthew Freeborn, Cle Elum, WA (US)

(73) Assignee: Zacklift International, Cle Elum, WA (US)

(21) Appl. No.: 18/562,308

(22) PCT Filed: Nov. 9, 2022
(86) PCT No.: PCT/US22/79551

§ 371 Date: Nov. 18, 2023

Related U.S. Application Data
(60) Provisional application No. 63/277,520, filed on Nov. 9, 2021.

(51) Int. Cl. B60D 1/04; B60D 1/28; B60D 1/36; B60P 3/12

(52) U.S. Cl. CPC B60D 1/04; B60D 1/28; B60D 1/36; B60P 3/12

(57) ABSTRACT

A device for holding a hook to a vehicle, includes a housing that is mountable to a vehicle and a holder that is operable to releasably hold a hook. The holder is coupled with the housing and configured to hold the hook when the hook is positioned in the holder, and release the hook when the hook is urged against the holder and applies a force to the holder that exceeds a threshold amount of force. With a holder that is configured to release the hook when the hook is urged against the holder and applies a force to the holder that exceeds a threshold amount of force, the hook may be firmly held in place and may be easily released when needed.

### CROSS REFERENCE TO RELATED APPLICATIONS AND INCORPORATION BY REFERENCE

This application claims priority from U.S. PCT Patent Application PCT/US22/79551 filed on 9 Nov. 2022 and titled “DEVICE FOR HOLDING A HOOK TO A VEHICLE, AND RELATED METHODS AND COMPONENTS”, and from U.S. Provisional Patent Application 63/277,520 filed 9 Nov. 2021, and titled “Holder Or Keeper For A Hook Of A Wrecker, And Related Methods And Components”. This application also incorporates by this reference the entirety of U.S. PCT Patent Application PCT/US22/79551, and the entirety of U.S. Provisional Patent Application 63/277,520.

### BACKGROUND

Many tow trucks and wreckers include a hook system that one can use to help maneuver a disabled vehicle into a position in which one can couple the disable vehicle to the tow truck or wrecker. Such hook systems typically include a hook attached to a cable that is coupled with a winch. The winch unspools and then with much power spools the cable to pull the hook and the disabled vehicle that the hook is coupled with to the truck or wrecker. Such a hook system is typically used after a vehicle that has lost control and ends up in a ditch, on soft ground next to the road, on its side, or upside down. The hook system can be used to roll a vehicle back onto it wheels, or drag a vehicle onto firmer ground or the road. With the vehicle on its wheels and positioned on firm ground, one can then hook the vehicle up to a tow truck or wrecker and tow the vehicle away for repair or disposal.

While a tow truck and/or wrecker drives out to help a disabled vehicle or while it drives back towing the disabled vehicle, the hook is often disconnected from the cable and the cable withdrawn up to the winch. This keeps the hook from flying around and banging into other parts of the tow truck, which could damage the tow truck or wrecker. If the driver of the tow truck and/or wrecker needs to use the hook, he/she then has to connect the hook to the cable. To do this he/she has to find the hook and the associated coupler and then couple the hook to the cable carefully so that coupler won't fail when the hook and cable pulls or rolls a vehicle a thus experiences a substantial load. To avoid having to connect and disconnect the hook, some tow trucks and wreckers include a loop mounted to the body of the two truck or wrecker to hold the hook when the hook is not needed. Unfortunately, though, the loop doesn't prevent the hook from moving within the loop while the tow truck and/or wrecker drives to and from a disabled vehicle. Because of this movement, the hook and loop rub against each other and expose material of each to corrosion and excessive wear. This, in turn, can cause the hook to suddenly fail when it experiences a substantial load.

Thus, there is a need for a device that holds a hook of a tow truck or wrecker without having to disconnect the hook from the cable, and that does not allow the hook to move while the tow truck and/or wrecker is driven to and from a disable vehicle.

### SUMMARY

In an aspect of the invention, a device for holding a hook to a vehicle, includes a housing that is mountable to a vehicle and a holder that is operable to releasably hold a hook. The holder is coupled with the housing and configured to hold the hook when the hook is positioned in the holder, and release the hook when the hook is urged against the holder and applies a force to the holder that exceeds a threshold amount of force.

With a holder that is configured to release the hook when the hook is urged against the holder and applies a force to the holder that exceeds a threshold amount of force, the hook may be firmly held in place and may be easily released when needed. By establishing a threshold amount force needed to release the hook from the holder, one can urge the hook against the holder with a force that is less than a threshold amount but sufficient to keep the hook from moving in the holder. Then, when one needs to use the hook, one simply urges the hook against the holder with a force sufficient to cause the holder to release the hook. In addition, when the holder firmly holds the hook, the tension in the cable that couples the hook with a tow truck or wrecker's winch prevents the cable from “bird nesting” around the winch—i.e., loosely spooling around the drum of the winch.

In another aspect of the invention, a method for holding a hook to a vehicle includes: 1) holding a hook with a holder of a device, wherein the holder is coupled with a body of the device and the body is mounted to a vehicle; and 2) releasing the holder's hold on the hook by: a) urging the hook against the holder; and b) applying a threshold amount of force to the hook to cause the holder to release the hook.

In yet another aspect of the invention a vehicle includes a body; a winch mounted to the body and operable to pull a cable; a hook attached to the cable; and a device operable to hold the hook to the body. The device includes a housing mountable to the body; and a holder operable to releasably hold the hook. The holder is coupled with the housing and configured to hold the hook when the hook is positioned in the holder, and release the hook when the hook is urged against the holder and applies a force to the holder that exceeds a threshold amount of force.

### BRIEF DESCRIPTION OF THE FIGURES

FIG. 1 shows a perspective view of a device holding a hook, according to an embodiment of the invention.

FIG. 2 shows a perspective view of the device shown in FIG. 1, showing a holder of the device in a first position and showing a housing of the device transparent to show the coupling of the holder with the housing, according to an embodiment of the invention.

FIG. 3 shows a perspective view of the device shown in FIG. 1, showing a holder of the device in a second position and showing a housing of the device transparent to show the coupling of the holder with the housing, according to an embodiment of the invention.

FIG. 4 shows a cut-away view of a portion of the device shown in FIGS. 1 and 2 with the holder in the first position, according to an embodiment of the invention.

FIG. 5 shows a cut-away view of a portion of the device shown in FIGS. 1 and 3 with the holder in the second position, according to an embodiment of the invention.

FIG. 6 shows another view of the device shown in FIG. 1, according to another embodiment of the invention.

### DETAILED DESCRIPTION

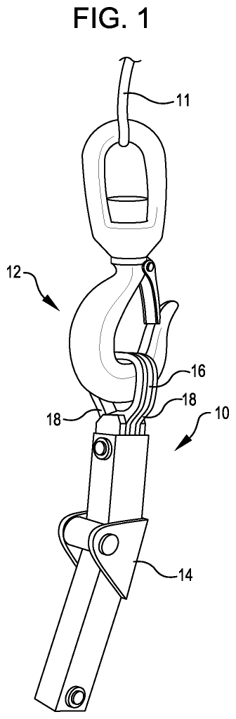

FIG. 1 shows a perspective view of a device 10 holding a hook 12, according to an embodiment of the invention. The device 10 includes a housing 14 and a holder 16. The housing 14 is mountable to a vehicle such as a tow truck (not shown) or a wrecker (also not shown). The holder 16 is coupled with the housing 14 and releasably holds the hook 12. As shown in FIG. 1, a cable 11 urges the hook 12 up against the holder 16 with a force that is less than a threshold amount, and the holder 16 firmly holds the hook 12. When the hook 12 is urged up against the holder 16 with a force that exceeds the threshold amount, the holder 16 releases its hold on the hook 12 allowing the hook 12 to move up, away from the device 10.

With the holder 16 configured to release the hook 12 when the hook 12 is urged against the holder 16 and applies a force to the holder 16 that exceeds the threshold amount of force, the hook 12 may be firmly held in place and may be easily released when needed. By establishing a threshold amount of force needed to release the hook 12 from the holder 16, one can urge the hook 12 against the holder 16 with a force that is less than a threshold amount but sufficient to keep the hook 12 from moving in the holder 16. Then, when one needs to use the hook 12, one simply urges the hook 12 against the holder 16 with a force sufficient to cause the holder 16 to release the hook 12. In addition, when the holder firmly holds the hook, the tension in the cable that couples the hook with a tow truck or wrecker's winch prevents the cable from “bird nesting” around the winch—i.e., loosely spooling around the drum of the winch.

The threshold amount of force needed to cause the holder 16 to release the hook 12 may be any desired amount of force that is a greater than the amount of force sufficient to keep the hook 12 up against the holder 16 and keep the hook from swinging or pivoting relative to the holder 16. For example, in this and other embodiments the threshold amount of force is 60 to 80 pounds. With his amount, the inertial forces generated by the hook 12 when the hook and holder change directions in space, such as when the vehicle turns, travels over the crest of a hill, or travels over a bump; or when the hook 12 experiences a force external to the holder 16, such as wind resistance, will not cause the hook 12 to move relative to the holder 16.

The housing 14 may be mounted to the body of a tow truck or wrecker using any desired technique. For example, in this and other embodiments, the housing 14 is releasably mounted to the body (not shown) of a wrecker to securely anchor the device 10 to the wrecker yet allow one to remove the device 10 from the wrecker and then relocate the device on the same or a different wrecker, if desired. In other embodiments, the device 10 may be permanently mounted to the body by welding the housing 14 to the body.

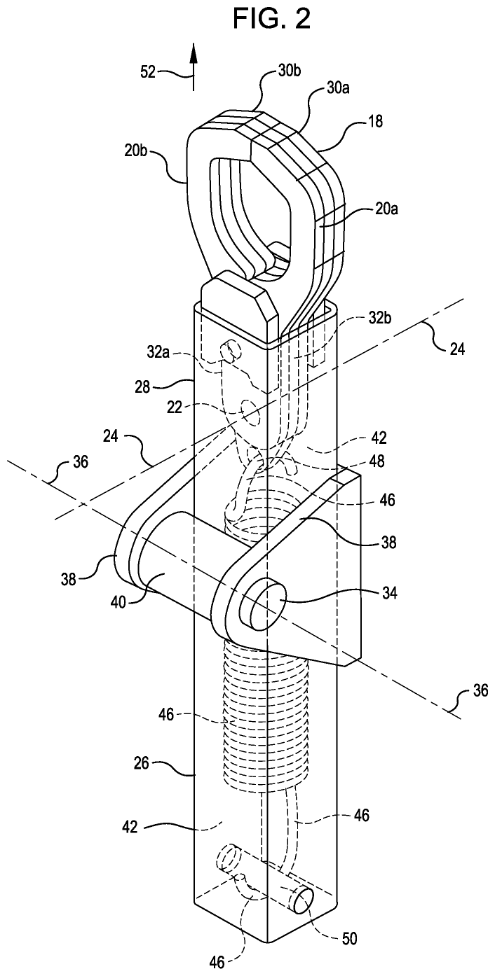

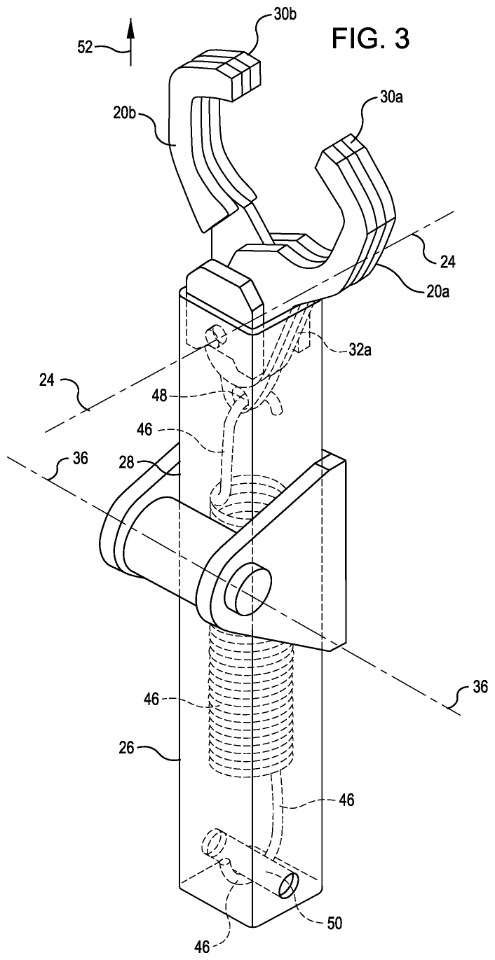

Still referring to FIG. 1, the holder 16 may be configured as desired to releasably hold the hook 12 and release the hook 16 when the hook 16 applies a threshold amount of force to the holder 16. In addition, the holder 16 may be coupled with the housing 14 using any desired technique. For example, in this and other embodiments, the holder 16 includes a clasp 18 that may be maneuvered into a first position (a closed position), maneuvered into a second position (an open position), and that is coupled with the housing 14 via a spring (not shown in FIG. 1, but shown in FIGS. 2 and 3). This embodiment of the holder 16 and its coupling with the housing 14 is discussed in greater detail in conjunction with FIGS. 2-6. As shown in FIG. 1, the clasp 18 firmly holds the hook 12 because the clasp 18 is in the first position (closed), and the hook 12 is urged up against the clasp 18 such that the hook 12 applies a force against the clasp 18 that is less than the threshold amount that would cause the clasp 18 to open into the second position. Then, when the hook 12 is urged against the clasp 18 such that the hook applies a force that exceeds the threshold amount, the clasp 18 opens to the second position (shown in FIGS. 3 and 5) and allows the hook 12 to move up and away from the clasp 18.

Each of FIGS. 2 and 3, shows a perspective view of the device 10 shown in FIG. 1 with the housing 14 transparent to show the coupling of the clasp 18 with the housing 14, according to an embodiment of the invention. FIG. 2 also shows the clasp 18 in the first position, according to an embodiment of the invention; and FIG. 3 shows the clasp 18 in the second position, according to an embodiment of the invention.

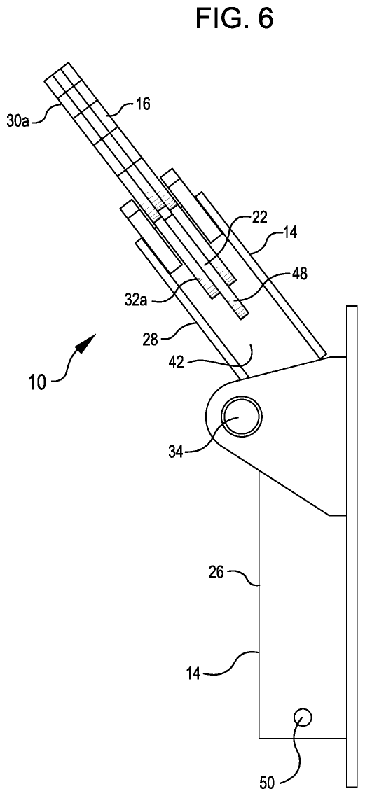

The clasp 18 and housing 14 may be configured as desired. For example, in this and other embodiments the clasp 18 includes two jaws 20a and 20b each pivotally coupled with the other via a first pin 22 located at a first pivot axis 24, and the housing 14 includes a first portion 26 and a second portion 28, each portion having a square cylinder. Each of the jaws 20a and 20b includes a distal end 30a and 30b, respectively, and a proximal end 32a and 32b, respectively, where the jaws 20a and 20b are coupled with each other. The first portion 26 of the housing 14 is coupled with the second portion 28 of the housing 14 via a second pin 34 located at a second axis 36 to allow the second portion 28 to pivot relative to the first portion 26 (discussed in greater detail in conjunction with FIG. 6). More specifically, the first portion 26 of the housing 14 is welded to the bracket 38, while the second portion 28 of the housing 14 is welded to the sleeve 40. As the second portion 28 pivots about the second axis 36, the sleeve 40 rotates relative to the second pin 34. Each of the first and second portions 26 and 28, respectively, includes a cavity that combine to form a single cavity 42 that spans both portions 26 and 28. Within this cavity 42 lies the spring 46 that couples the clasp 18 with the housing 14. More specifically, the spring 46 couples a tab 48 of the clasp 18 with an anchor 50 of the first portion 28. The tab 48 is coupled with each of the proximal ends 32a and 32b via the first pin 22 at the first pivot axis 24 such that each of the proximal ends 32a and 32b may rotate relative to the tab 48.

The first and second positions of the clasp 18 may be any desired positions in which the clasp 18 holds the hook 12 when the clasp 18 is in the first position (FIG. 2), and the clasp 18 releases the hook 12 when the clasp 18 is in the second position (FIG. 3). For example, in this and other embodiments, when the clasp 18 is in the first position, the proximal ends 32a and 32b of the jaws 20a and 20b are located in the portion of the cavity 42 that is inside the housing's second portion 28, and the distal ends 30a and 30b contact each other to form a loop. When the clasp 18 is in the second position, the proximal ends 32a and 32b of the jaws 20a and 20b remain in the cavity 42 but are located further away from the anchor 50 than they are in the first position, and the distal ends 30a and 30b do not contact each to open the loop. More specifically, the clasp 18 moves in the direction indicated by the arrow 52 to reach the second position and release the hook 12.

Other embodiments are possible. For example, the change in positions of the clasp 18 from the first position to the second position may not include movement of the whole clasp 18 relative to the housing 14 in the direction of the arrow 52, but rather one or more jaws of the clasp 18 moving relative to the other jaw without the clasp 18 moving in the direction of the arrow 52. For another example, the change in positions of the clasp 18 from the first position to the second position may include movement of the clasp 18 in a direction other than in the direction indicated by the arrow 52.

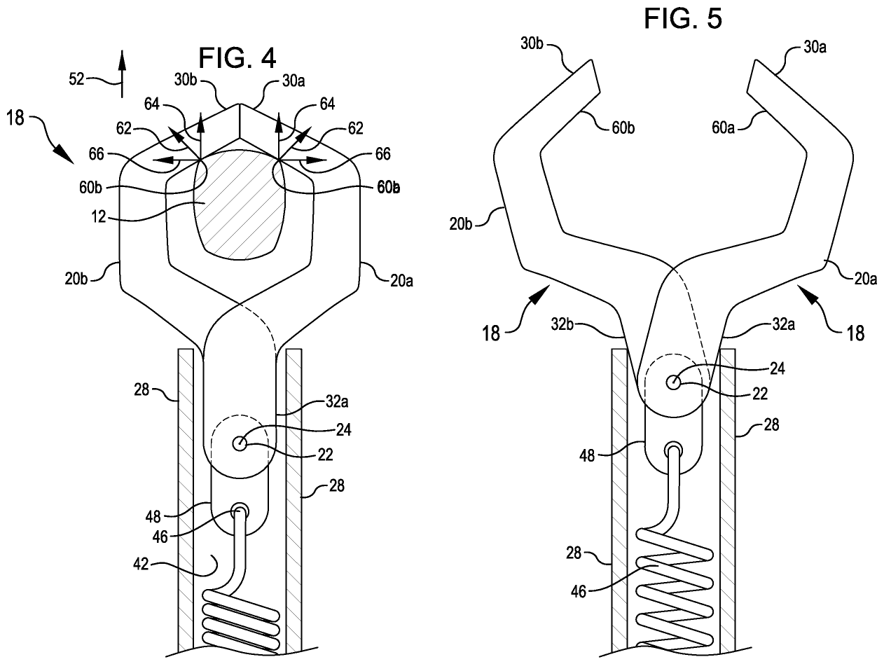

In operation, the spring 46 urges the clasp 18 to and maintains the clasp 18 in the first position. In this position, the spring 46 remains stretched a distance relative to its natural, unstretched state and thus pulls on the tab 48 with a force that is directly proportional to the distance that it's stretched. In this and other embodiments this force is 35 to 40 pounds. To keep the spring from pulling the whole clasp 18 into the housing's cavity 42, each of the jaws 20a and 20b contacts the edge of the second portion's cylindrical body where the jaws 20a and 20b extend out of the cavity 42 (discussed in greater detail in conjunction with FIG. 4). This contact also urges the distal ends 30a and 30b against each other, thus closing the clasp 18 to form the loop. After a portion of the hook 12 is inserted through the loop, the hook 12 is pulled away from the housing's second portion 28 and contacts the distal ends 30a and 30b of the jaws 20a and 20b. Because the jaws 20a and 20b are confined by the edge of the second portion's cylindrical body, the distal ends 30a and 30b are prevented from rotating relative to each other when the hook 12 applies a force in the direction indicated by the arrow 52 that is less than the force that the spring 46 applies to the proximal ends 32a and 32b. Thus, in this embodiment the threshold amount of force (here 60-80 pounds) is the amount force required to extend the spring to the clasp's second position, where the jaws 20a and 20b are free to rotate away from each other. After the hook 12 passes through the opening between the distal ends 30a and 30b when the clasp 18 is in the second position, the spring 46 pulls the proximal ends 32a and 32b back toward the anchor 50 and into the cavity 42 until the jaws 20a and 20b contacts the edge of the second portion's cylindrical body. In this manner, one can modify the threshold amount of force required to open the clasp 18 by using a spring 46 that generates more or less force when the spring 46 is stretched the same distance away from its natural unstretched state.

FIG. 4 shows a cut-away view of a portion of the device 10 shown in FIGS. 1 and 2 with the clasp 18 in the first position, according to an embodiment of the invention. FIG. 5 shows a cut-away view of a portion of the device 10 shown in FIGS. 1 and 3 with the clasp 18 in the second position, according to an embodiment of the invention.

Each of the distal ends 30a and 30b of the jaws 20a and 20b, respectively may be configured as desired. For example, in this and other embodiments the configuration of each of the distal ends 30a and 30b is identical to the other. More specifically, each includes a contact surface 60a and 60b, respectively, where the hook 12 contacts the clasp 18 when the clasp 18 holds the hook 12. Each of the contact surfaces 60a and 60b are oriented such that when the hook 12 is urged in the direction of the arrow 52 and applies a force to each of the distal ends 30a and 30b, the force experienced by each of the distal ends 30a and 30b (represented by the arrow 62) has a vertical component (represented by the arrow 64) and a horizontal component (represented by the arrow 66). Because the force that the hook 12 applies to the jaws 20a and 20b is applied over both distal ends 30a and 30b, the force experienced by each of the distal ends 30a and 30b is less than the total force applied by the hook 12. When the summation of both vertical components 64 of the force 62 equals the amount of force that the spring 46 applies to the proximal ends 32a and 32b of the jaws 20a and 20b, respectively, then the jaws begin to move in the direction of the arrow 52 toward the second position. As this occurs the amount of force that the spring 46 exerts on the distal ends 30a and 30b increases because the spring 46 is further stretched from its natural unstretched state. Eventually, the hook 12 applies enough force—the threshold amount of force—to move the jaws 20a and 20b far enough out of the cavity 42 (second position) to allow the horizontal components 66 of the force 62 to push the distal ends 30a and 30b away from each other. This opens the clasp 18 and allows the hook 12 to move out away from the clasp 18.

FIG. 6 shows another view of the device 10 shown in FIG. 1, according to another embodiment of the invention. As previously discussed, the second portion 28 of the device's housing 14 is pivotally coupled with the first portion 26 of the device's housing 14 to allow one to position the clasp 18 in a variety of different locations to facilitate the clasp's firm hold of the hook 12, and the later release of the hook 12. The mechanism for releasing the hook 12 previously discussed works best when the hook 12 applies a force to the distal ends 30a and 30b of the clasp 18 in a direction that is aligned with the movement of clasp 18 out of the cavity 42. In this manner, the vertical and horizontal components 64 and 66 (FIG. 4), respectively, of the total applied force 62 (FIG. 4) urge the clasp 18 as designed. As a result, the amount of force that will cause the clasp 18 to open will be the designed threshold amount or very close to it. If, the force applied by the hook 12 was applied in a direction that is not aligned with the movement of clasp 18 out of the cavity 42, then it would take more than the threshold amount force to release the hook 12. Such a force would attempt to wrench or rotate the clasp 18 out of the cavity 42. Because the cable 11 (FIG. 1) that the hook 12 is coupled with often extends from the end of a boom which is typically not directly above the clasp 18, pivoting the housing's second portion 28 allows one to position the clasp 18 so that it points toward the end of the boom. In addition, pivoting the housing's second portion 28 allows one to position the clasp 18 away from the body of the tow truck or wrecker that the device 10 is mounted to and provide easier access to the clasp 18. Then, when the hook 12 is released from the clasp 18, the spring 46 (FIGS. 2-5) urges the second portion 28 back into alignment with the first portion 26 (see FIGS. 2 and 3) to keep the second portion 28 out of the way while one uses the hook and/or other components of the tow truck or wrecker to position a disabled vehicle.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A device for holding a hook to a vehicle, the device comprising:
a housing mountable to a vehicle; and
a holder coupled with the housing and operable to releasably hold a hook, the holder configured to:
hold the hook when the hook is positioned in the holder, and
release the hook when the hook is urged against the holder and applies a force to the holder that exceeds a threshold amount of force.

2. The device of claim 1 wherein:
the holder includes a clasp that may be opened and closed, and
to hold the hook, a portion of the hook is inserted through a loop formed by the clasp when the clasp is closed.

3. The device of claim 2 wherein the threshold amount of force opens the clasp when the clasp is closed.

4. The device of claim 1 wherein the threshold amount of force required for the clasp to release the hook is 60-80 pounds.

5. The device of claim 1 wherein the housing includes a square cylinder having a first portion, a second portion, and a cavity that extends into both the first and second portions, the second portion pivotable relative to the first portion.

7. The device of claim 1 wherein a spring couples the holder with the housing and urges the holder against the housing.

8. The device of claim 1 wherein:
the housing includes a square cylinder having a first portion, a second portion, and a cavity that extends into both the first and second portions, the second portion pivotable relative to the first portion, and
a spring couples the holder with the housing, urges the holder against the second portion, and allows the holder to move relative to the housing's first portion.

9. The device of claim 1 wherein:
the holder includes a clasp that may be opened and closed, the clasp having a first jaw and a second jaw, wherein each jaw:
has a distal end,
is pivotable relative to the other jaw, and
is configured such that when the clasp is closed the distal ends of the jaws contact each other, and when the clasp is open the distal ends of the jaws do not contact each other, and
to hold the hook, a portion of the hook is inserted through a loop formed by the first and second jaws when the clasp is closed.

10. The device of claim 9 wherein each jaw is pivotable relative to the other jaw about the same pivot axis, and the distal end of each jaw includes a contact surface where the hook contacts the jaw when the clasp is closed and holds the hook, each contact surface oriented on its respective jaw such that when the threshold amount of force is applied by the hook to the closed clasp, a portion of the threshold amount of force is applied to each of the contact surfaces in a direction away from the other contact surface.

11. The device of claim 10 wherein:
the housing includes a square cylinder having a first portion, a second portion, and a cavity that extends into both the first and second portions,
each jaw has a proximal end that is pivotally coupled with the other jaw, and disposed in a portion of the housing's cavity that is located in the second portion of the housing,
a spring couples the proximal ends of the clasp's jaws with the first portion of the housing and urges the proximal ends to a first position within the cavity in the housing's second portion such that the housing of the second portion prevents each jaw from pivoting relative to the other jaw to open the clasp, and
wherein when the threshold amount of force is applied by the hook to the closed clasp, the threshold amount of force moves the clasp's proximal ends to a second position within the cavity in the housing's second portion such that the housing of the second portion no longer prevents each jaw from pivoting relative to the other jaw to open the clasp.

12. A vehicle comprising:
a body;
a winch mounted to the body and operable to pull a cable;
a hook attached to the cable; and
a device operable to hold the hook to the body, the device comprising:
a housing mountable to the body; and
a holder coupled with the housing and operable to releasably hold the hook, the holder configured to:
hold the hook when the hook is positioned in the holder, and
release the hook when the hook is urged against the holder and applies a force to the holder that exceeds a threshold amount of force.

13. The vehicle of claim 12 wherein the vehicle is a wrecker.

14. The vehicle of claim 12 wherein the vehicle includes two hooks and two devices, each operable to hold a respective one of the two hooks.

15. A method for holding a hook to a vehicle, the method comprising:
holding a hook with a holder of a device, wherein the holder is coupled with a body of the device and the body is mounted to a vehicle;
releasing the holder's hold on the hook by:
urging the hook against the holder; and
applying a threshold amount of force to the hook to cause the holder to release the hook.

16. The method of claim 15 wherein holding a hook with a holder includes pivoting the holder relative to a portion of the body to position the holder.

17. The method of claim 15 wherein holding a hook with a holder includes:
closing a clasp to a form a loop, and
inserting a portion of the hook through the loop.

18. The method of claim 15 wherein holding a hook with a holder includes a spring urging a proximal end of two jaws of a clasp to a first position within a cavity of the device's body, wherein in the first position the device's body prevents each jaw from pivoting relative to the other jaw to open the clasp.

19. The method of claim 15 wherein urging the hook against the holder includes urging the hook against a contact surface of a distal end of each of two jaws.

20. The method of claim 15 wherein applying a threshold amount of force to the hook to cause the holder to release the hook includes pivoting a first jaw relative to a second jaw wherein the first and second jaws are pivotally coupled with each other.

21. The method of claim 15 wherein applying a threshold amount of force to the hook to cause the holder to release the hook includes applying a portion of the force to a contact surface of a distal end of each of two jaws.

22. The method of claim 15 wherein applying a threshold amount of force to the hook to cause the holder to release the hook includes:
moving a proximal end of two jaws of a clasp to a second position within a cavity of the device's body, wherein in the second position the device's body does not prevent each jaw from pivoting relative to the other jaw to open the clasp, and
pushing a distal end of two jaws away from each other to open the clasp.
